(19) United States
(12) Patent Application Publication
(10) Pub. No.: US 2010/0238417 A1
(43) Pub. Date: Sep. 23, 2010

(54) IMAGING DEVICE

(75) Inventors: Ulrich Streppel, Regensburg (DE); Michael Reich, Regensburg (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: OSRAM OPTO SEMICONDUCTORS GMBH, Regensburg (DE)

(21) Appl. No.: 12/669,222

(22) PCT Filed: Aug. 7, 2008
(86) PCT No.: PCT/DE2008/001289

§ 371 Date: May 12, 2010

(30) Foreign Application Priority Data
Aug. 8, 2007 (DE) 10 2007 037 443.9
Jan. 8, 2008 (DE) 10 2008 003 451.7

(51) Int. Cl. G03B 21/14; G03B 21/28; G03B 21/00

(52) U.S. Cl. 353/84; 353/98; 353/122

(57) ABSTRACT

An imaging device for projecting an image onto a projection area includes a radiation-emitting component which emits electromagnetic radiation along an emission direction during operation, an image-generating element in the beam path of the radiation-emitting component, a radiation-directing element in the beam path of the radiation-emitting component for directing the electromagnetic radiation onto the projection area, and a radiation exit area, wherein the projection area is offset laterally with respect to the radiation exit area.

### RELATED APPLICATIONS

This is a §371 of International Application No. PCT/DE2008/001289, with an international filing date of Aug. 7, 2008 (WO 2009/018818 A1, published Feb. 12, 2009), which is based on German Patent Application Nos. 10 2007 037 443.9, filed Aug. 8, 2007, and 10 2008 003 451.7, filed Jan. 8, 2008, the subject matter of which are hereby incorporated by reference.

### TECHNICAL FIELD

This disclosure relates to an imaging device for projecting an image onto a projection area.

### SUMMARY

We provide an imaging device for projecting an image onto a projection area including a radiation-emitting component which emits electromagnetic radiation along an emission direction during operation, an image-generating element in a beam path of the radiation-emitting component, a radiation-directing element in the beam path of the radiation-emitting component that directs the electromagnetic radiation onto the projection area, and a radiation exit area, wherein the projection area is offset laterally with respect to the radiation exit area.

### BRIEF DESCRIPTION OF THE DRAWINGS

Further advantages and advantageous aspects and developments will become apparent from the examples described below in conjunction with FIGS. 1 to 9.

In the figures:

FIG. 1 shows a schematic illustration of an imaging device in accordance with one example;

FIGS. 2A and 2B show schematic illustrations of an imaging device and of a radiation-directing element in accordance with further examples; and

FIGS. 3 to 9 show schematic illustrations of imaging devices in accordance with further examples.

### DETAILED DESCRIPTION

Our imaging devices comprise in particular:
a radiation-emitting component, which emits electromagnetic radiation along an emission direction during operation,
an image-generating element in a beam path of the radiation-emitting component,
a radiation-directing element in the beam path of the radiation-emitting component that directs the electromagnetic radiation onto the projection area, and
a radiation exit area,
   wherein
the projection area is offset laterally with respect to the radiation exit area.

In particular, the projection area can thereby also be tilted with respect to the radiation exit area.

An imaging device of this type has the advantage that it can be arranged in a manner laterally offset with respect to the projection area. This can mean that the imaging device can be arranged in particular in a manner laterally offset with respect to the image on the projection area. Consequently, the imaging device can be arranged in the field of view of an observer—who views the image—in a manner laterally offset with respect to the image and projection area without the imaging device concealing the image as seen from the observer. The imaging device can therefore be arranged alongside the projection area in a space-saving manner.

In this case, the image-generating element can be disposed downstream of the radiation-emitting component in the beam path, and the radiation-directing element can be disposed downstream of the image-generating element in the beam path of the radiation-emitting component.

In particular, the image-generating element can be disposed downstream of the radiation-emitting component directly, that is to say straight, in the beam path, and the radiation-directing element can be disposed downstream of the image-generating element directly, that is to say straight, in the beam path of the radiation-emitting component. A space-saving arrangement of the individual components of the imaging device and thus a compact design of the imaging device can be made possible as a result.

By way of example, the imaging device can project onto the projection area an image which has geometries, pictures or symbols and can thereby impart information to an observer, for instance. The radiation-emitting component thereby can be suitable in particular for emitting visible light. In this case, the light can be of a single color or multicolored and, in particular, enable a white-colored or varicolored luminous impression.

Furthermore, for generating the image the image-generating element can have for example an optical element that is at least partly transmissive to the electromagnetic radiation and/or an at least partly reflective optical element. This can mean that the radiation-emitting component transilluminates and/or illuminates the image-generating element and the spatial brightness and/or color locus variations required for the image thereby can case be impressed on the electromagnetic radiation.

In this case, the at least partly transmissive optical element can have at least two regions which have a mutually different transmission for the electromagnetic radiation. Thus, for instance, a first region can have a high transmission for the electromagnetic radiation and a second region can have a lower transmission, such that the image on the projection area can result by way of the difference in brightness between the regions of the at least partly trans-missive optical element that are projected onto the projection area. As an alternative or in addition, the at least two regions having a mutually different transmission can also be transmissive to different wavelengths of the electromagnetic radiation generated by the radiation-emitting component and therefore enable a multicolored image. Furthermore, the at least partly transmissive optical element can have a matrix that is at least partly transparent to the electromagnetic radiation, which matrix can comprise a multiplicity of differently transparent regions. In this case, the differently transparent regions can be embodied in the form of pixels, that is to say, for example, image points arranged in lines and columns. As an alternative or in addition, the differently transparent regions can also have at least in part information-carrying forms.

In this case, the at least partly transmissive optical element can comprise a liquid crystal matrix and/or a structured color filter. In the case of a liquid crystal matrix, in particular, the image that can be projected onto the projection area can be temporally variable.

The radiation-directing element can furthermore comprise a lens or a lens segment and be suitable for directing the electromagnetic radiation onto the projection area and thereby for collimating or focusing the electromagnetic radiation. In particular, the lens or the lens segment can be arranged in off-center fashion with respect to the radiation-emitting component. This can mean, for example, that the lens or the lens segment has an optical axis and the optical axis is arranged for example in a manner tilted and/or shifted in parallel fashion with respect to the arrangement direction of radiation-emitting component and image-generating element.

Furthermore, the radiation-directing element can simultaneously be formed as the image-generating element. This can mean that the image-generating element is formed as part of the radiation-directing element. In particular, by way of example, an at least partly transmissive optical element can be formed on or in the radiation-directing element. Furthermore, the radiation-directing element can be formed in such a way that the electromagnetic radiation is not directed uniformly onto the projection area, but rather is collimated or focused to differing extents, for example, onto different partial regions of the projection area, whereby differences in brightness, for example, can be made possible on the projection area. For this purpose, the radiation-directing element can have, for example, a suitably shaped surface formed as a freeform area.

Furthermore, the radiation-directing element can have a mirror. In this case, the mirror can be embodied in plane or curved fashion, for instance spherical, elliptical, parabolic or a combination thereof. The mirror can furthermore be arranged in rigid or movable fashion, in the latter case for instance to alter the position of the image on the projection area or to enable an image on the projection area by line-by-line and column-by-column following of individual pixels in conjunction with a temporally variable image-generating element such as, for instance, a liquid crystal matrix or a liquid crystal element.

Furthermore, the image-generating element can also have a mirror that can be at least partly reflective for the electromagnetic radiation. For this purpose, the mirror can have for example a structured surface and/or color filters and/or a liquid crystal matrix on a reflective surface.

In this case, the radiation-emitting component can be arranged in such a way that the emission direction is directed away from the projection area. This can mean that the radiation-emitting component, for example, on account of spatial boundary conditions and stipulations, can be arranged in a space-saving manner in the imaging device and, as a result, the emission direction can be directed away from the projection area. However, the radiation-directing element can nevertheless direct the electromagnetic radiation onto the projection area.

The radiation-emitting component can comprise a semiconductor light-emitting diode (LED) or be an LED. In this case, the LED can preferably emit single- or mixed-colored radiation and for example furthermore have wavelength conversion substances. The LED can have for example a semiconductor layer sequence having one or more active regions which generates electromagnetic radiation during operation, in particular, when a current is impressed. Furthermore, the radiation-emitting component can have or be a plurality of LEDs, in particular, an LED array.

The semiconductor layer sequence can be embodied as an epitaxial layer sequence, that is to say as a semiconductor layer sequence grown epitaxially. In this case, the semi-conductor layer sequence can be embodied, for example, on the basis of an inorganic material, for instance InGaAlN, such as GaN thin-film semiconductor chips, for instance. InGaAlN-based semiconductor chips include, in particular, those in which the epitaxially produced semi-conductor layer sequence, which generally has a layer sequence comprising different individual layers, contains at least one individual layer which comprises a material from the III-V compound semiconductor material system InₓAl_{y}Ga_{1-x-y}N where 0≦x≦1,0≦y≦1 and x+y≦1. As an alternative or in addition, the semiconductor layer sequence can also be based on InGaAlP, that is to say that the semiconductor layer sequence has different individual layers, of which at least one individual layer comprises a material from the III-V compound semiconductor material system InₓAl_{y}Ga_{1-x-y}P where 0≦x≦1,0≦y≦1 and x+y≦1. As an alternative or in addition, the semiconductor layer sequence can also comprise other III-V compound semiconductor material systems, for example, an AlGaAs-based material, or II-VI compound semiconductor material systems.

The semiconductor layer sequence can have as active region, for example, a conventional pn junction, a double heterostructure, a single quantum well structure (SQW structure) or a multiple quantum well structure (MQW structure). Besides the active region, the semiconductor layer sequence can comprise further functional layers and functional regions, for instance p- or n-doped charge carrier transport layers, that is to say electron or hole transport layers p- or n-doped confinement or cladding layers, barrier layers, planarization layers, buffer layers, protective layers and/or electrodes and also a combinations thereof. Such structures concerning the active region of the further functional layers and regions are known to the person skilled in the art in particular with regard to construction, function and structure and are therefore not explained in any further detail at this point.

Furthermore, the radiation-emitting component can have an optical element for focusing or collimating the electromagnetic radiation generated by the semiconductor layer sequence. Such an optical element can have, for example, a lens, a lens array, an optical concentrator or combinations thereof. In this case, the optical element can be arranged directly on the semiconductor layer sequence or be spaced apart from the semiconductor layer sequence.

Furthermore, the radiation-emitting component, the image-generating element, the radiation-directing element and the radiation exit area can be arranged in a housing. The housing can be thereby, for example, the housing of a portable electronic device such as, for instance, a mobile telephone, a digital camera, an MP3 or multimedia player, a Personal Digital Assistant (PDA) or portable computer. The imaging device can therefore be embodied as part of such an electronic device. In contrast to conventional independent projection devices such as projectors and beamers, for instance, which have previously had to be additionally connected to electronic devices mentioned above and which have a considerable space requirement, in accordance with the embodiments described compact, space-saving imaging devices can be integrated in portable electronic devices.

In particular, the radiation exit area can in this case be formed as an opening or window in the housing. Furthermore, for example, an area of a radiation-directing element, for instance if it comprises a lens or a lens segment as described above, can also form the radiation exit area or be comprised by the latter.

Furthermore, the radiation exit area can be arranged such that it is not parallel to the projection area. This can mean in particular that the imaging device for projecting an image is provided for being arranged in such a way with respect to the projection area that the radiation exit area and the projection area can be arranged at an angle of greater than 0° and less than 180° with respect to one another. In particular, the radiation exit area can be oriented perpendicular to the projection area. As a result, it can, be possible that the imaging device can be arranged alongside the projected image in laterally offset fashion on or at least near the projection area and in this case does not obstruct an observer's view of the image.

In the exemplary examples and figures, identical and identically acting constituent parts may in each case be provided with the same reference symbols. The elements illustrated and their size relationships among one another should not be regarded as true to scale, in principle; rather, individual elements, such as layers, structural parts, components and regions, for example, may be illustrated with exaggerated thickness or size dimensions for the sake of better representability and/or for the sake of better understanding.

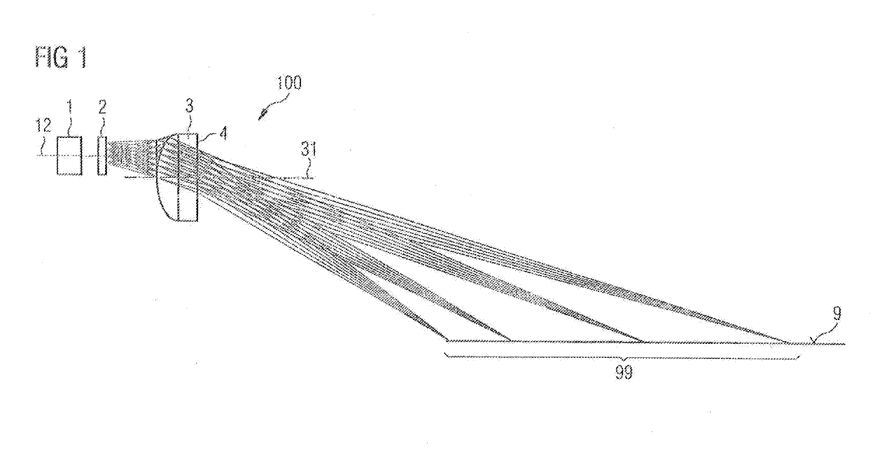

FIG. 1 shows an example of an imaging device 100 for projecting an image 99 onto a projection area 9. In this case, the imaging device 100 has a radiation-emitting component 1, which emits electromagnetic radiation along an emission direction during operation. In the example shown, the radiation-emitting component 1 comprises an LED with a collimation optical unit and emits white-colored or single-colored visible electromagnetic radiation during operation.

In the emission direction of the radiation-emitting component 1, which in this case is oriented parallel to the arrangement direction 12, an image-generating element 2 is arranged in the beam path of the electromagnetic radiation. The radiation-emitting component 1 and the image-generating element 2 define the arrangement direction 12. In this case, the image-generating element 2 is embodied as a partly transmissive optical element, for instance having regions of different transparency. The differently transparent regions of the image-generating element 2 impress on the electromagnetic radiation the spatial information required for the image 99 in the form of brightness and/or color variations. The collimation optical unit of the radiation-emitting component 1 concentrates the electromagnetic radiation onto the image-generating element 2.

Furthermore, a radiation-directing element 3 is arranged in the beam path of the radiation-emitting component 1, and can direct the electromagnetic radiation transmitted by the image-generating element 2 in the direction of a projection area 9. In this case, the projection area is not part of the imaging device 100 and can be a wall, a screen, a table area, a glass area or any other area.

In the example shown, the radiation-directing element 3 is a lens whose surface remote from the radiation-emitting component 1 forms the radiation exit area 4 of the imaging device 100. In this case, the radiation-directing element 3 has an optical axis 31 and is arranged with respect to the radiation-emitting component 1 and the image-generating element 2 in such a way that the optical axis is oriented in a manner shifted in parallel fashion with respect to the arrangement direction 12. The lens 3 is therefore arranged in off-center fashion with respect to the radiation-emitting component 1 and with respect to the image-generating element 2.

What can be achieved as a result is that the projection area 9 is laterally offset with respect to the radiation exit area 4 and, in particular, in the example shown, is arranged perpendicular to the radiation exit area 4. The image 99 therefore arises on the projection area 9 in a manner laterally offset with respect to the imaging device 100.

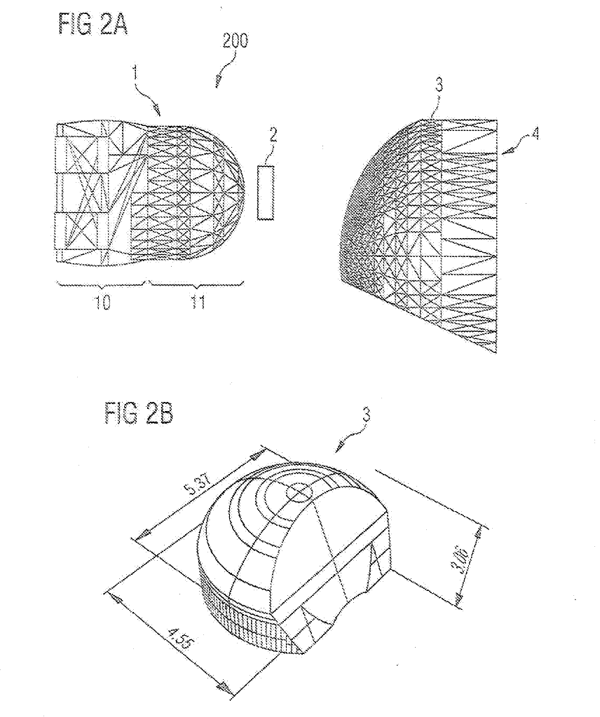

FIG. 2A shows a further example of an imaging device 200, in which the radiation-emitting component 1 has a housing with an LED 10 and an optical element 11 suitable for collimating or focusing the electromagnetic radiation generated by the LED 10 onto the image-generating element 2.

In contrast to the previous example, the radiation-directing element 3 is formed as a lens segment 3 in which the unilluminated region of the lens 3 as shown in FIG. 1 has been removed. A more compact construction of the imaging device 200 in conjunction with material and weight saving can be made possible as a result.

The distance between the image-generating element 2 and the radiation-directing element 3 is approximately 4 mm The lens segment 3 is shaped specifically for directing the electromagnetic radiation onto a projection area 9 (not shown) arranged perpendicular to the radiation exit area 4 and has the dimensioning indicated in FIG. 2B of approximately 3.06 mm height, approximately 5.37 mm diameter and approximately 4.55 mm width.

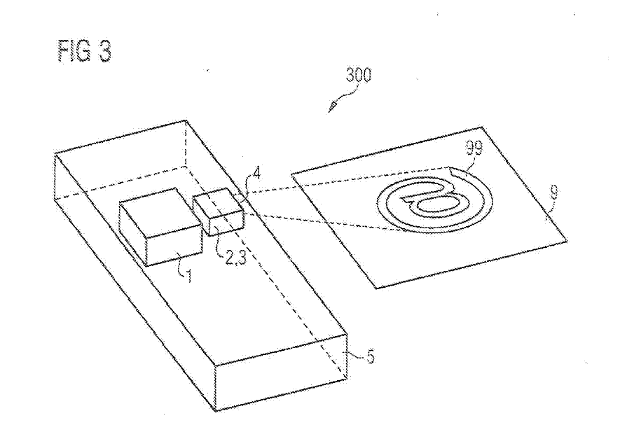

FIG. 3 shows a further example of an imaging device 300 in a three-dimensional illustration. In this case, the imaging device 300 can have a radiation-emitting component 1, an image-generating element 2, a radiation-directing element 3 and a radiation exit area 4 as shown in the previous examples, which are arranged in a housing 5. As shown in FIG. 3, the image-generating element 2 is simultaneously formed as a radiation-directing element 3. By way of example, a partly transparent, that is to say at least partly transmissive, optical element 2 as in the previous examples can be integrated into the radiation-directing element 3 or be arranged on the latter.

The housing 5 can be, for example, the housing of a portable electronic device, for instance a mobile telephone or a multimedia player. On any suitable projection area 9 offset laterally with respect to the imaging device 300, an image 99 that can be perceived by an observer can be generated alongside the imaging device 300.

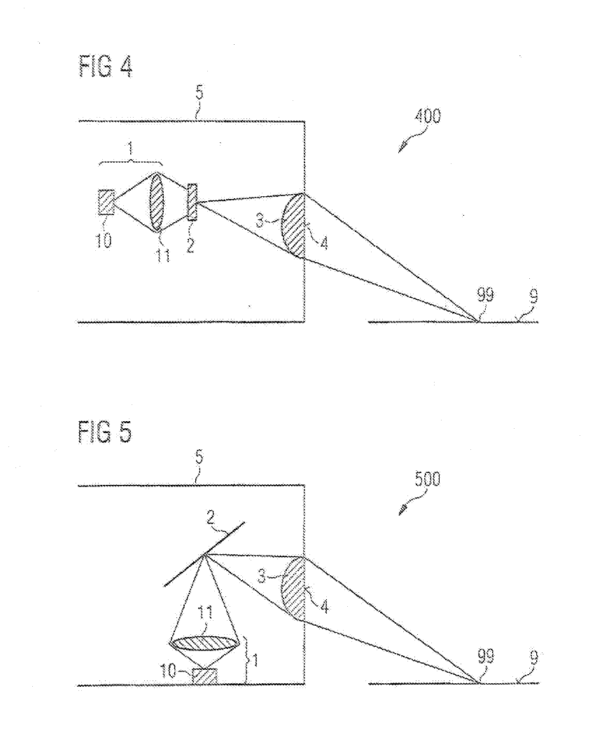

FIGS. 4 to 9 show further examples of imaging devices, wherein mounts, electrical and electronic drive systems and additional structural parts that are necessary in addition to the components shown are not shown for the sake of clarity.

The imaging device 400 in FIG. 4 has a radiation-emitting component 1 having an LED or an LED array 10 that can emit electromagnetic radiation. Furthermore, the radiation-emitting component has an optical element 11 in the form of a collimation or focusing optical unit, which concentrates or directs the electromagnetic radiation onto an at least partly trans-missive element 2.

In the example shown, the at least partly transmissive element 2 comprises an LED matrix that enables a temporally variable image 99 on a projection plane 9. As in the previous examples, the projection plane 9 is tilted with respect to radiation exit area 4. In this case, depending on the radiation-directing element 3, the projection area 9 can also be oriented at a different angle from the 90° shown.

The imaging device 500 in FIG. 5 has, as image-generating element 2, an at least partly reflective element 2 having a surface structured into differently reflective regions. As an alternative or in addition, the at least partly reflective element 2 can also have a liquid crystal matrix or a liquid crystal element in conjunction with a reflective rear side, whereby a temporally variable image 99 can be achieved, for example. The at least partly reflective element 2 can be mounted in rigid or movable fashion.

The radiation-emitting component 1 is mounted in the housing 5 in a plane having the same normal direction as the plane of the projection area 9. The emission direction of the radiation-emitting component 1 can therefore be directed away from the projection area 9, which may be advantageous, for example, with regard to a compact construction of the imaging device 500. The radiation-directing element 3 formed as a lens or lens segment directs the electro-magnetic radiation in the direction of the projection area 9.

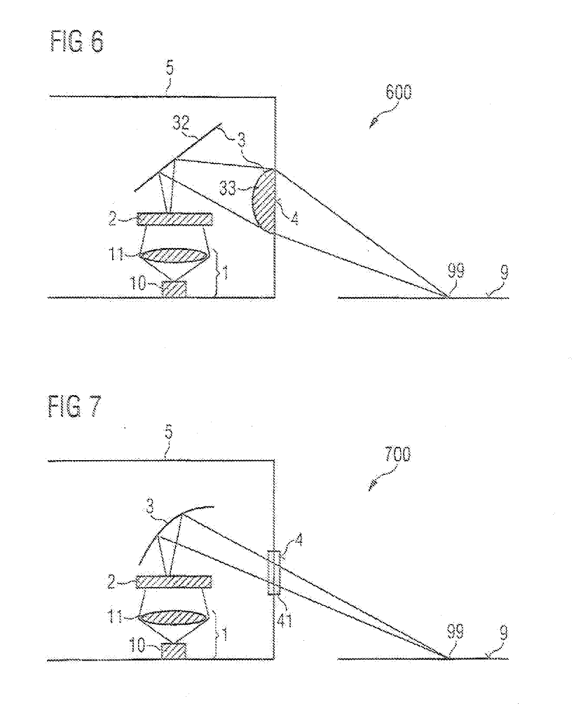

In the imaging device 600 in accordance with FIG. 6, the radiation-directing element 3 comprises a plane mirror 32 in combination with a lens 3 or a lens segment 33. As a result, the image-generating element 2, as described further above, can be formed for example as a liquid crystal matrix or as a liquid crystal element or have such a matrix or element, wherein an arrangement of the radiation-emitting component as in the example in accordance with FIG. 5 is possible.

The imaging device 700 in accordance with FIG. 7 has a concave mirror 3 as radiation-directing element 3, which, in comparison with the previous example, can simultaneously enable the deflecting function of the plane mirror 32 and the focusing or collimating and/or radiation-directing function of the lens 3 of the imaging device 600. In this case, the radiation exit area 4 is formed by a window 41 in the housing 5.

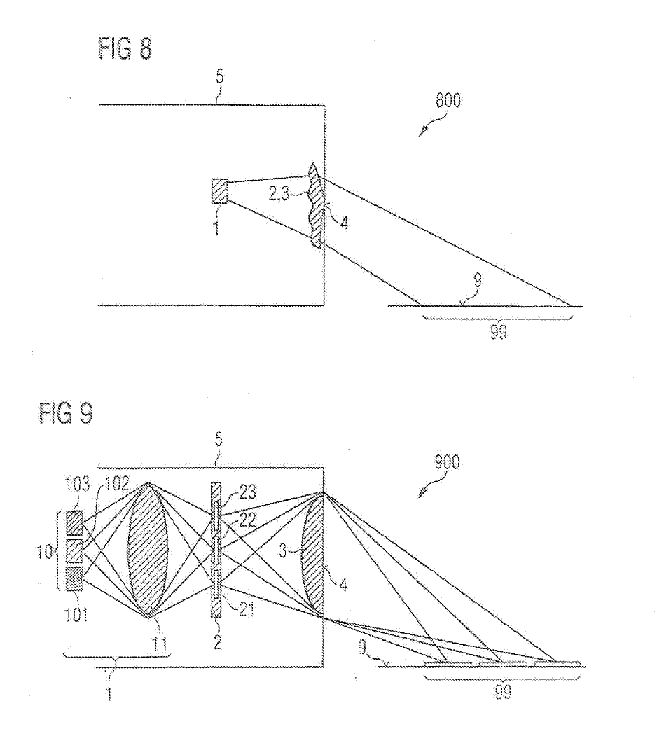

In the imaging device 800 in accordance with FIG. 8, the radiation-directing element 3 simultaneously forms the image-generating element 2. For this purpose, the radiation-directing and image-generating element 2, 3 is formed as a freeform optical unit which can be formed from one or more optical elements and is shaped such that an image as image 99 is made possible on the projection area 9. By virtue of the fact that no further optical elements are necessary, the imaging device 800 can be made very compact.

The imaging device 900 in accordance with the example in FIG. 9 has a radiation-emitting component 1 having an LED array 10 comprising different-colored LEDs 101, 102, 103. The LEDs 101, 102, 103 emit light with a different wavelength spectrum, e.g., with centroids at red, green, blue. The electromagnetic radiation emitted by the different LEDs 101, 102, 103 is concentrated onto an image-generating element 2 by means of the common collimation optical unit 11. The image-generating element 2 has a plurality of different partial regions 21, 22, 23, which can each have a color-selective coating for example in addition to a liquid crystal matrix, thereby enabling a multicolored image 99 on the projection area 9.

Further combinations of the functional principles and elements shown are also possible in addition to the examples shown.

This disclosure is not restricted to the examples by the description on the basis of the examples. Rather, the disclosure encompasses any new feature and also any combination of features, even if this feature or this combination itself is not explicitly specified in the examples.

1. An imaging device for projecting an image onto a projection area comprising:
a radiation-emitting component, which emits electromagnetic radiation along an emission direction during operation,
an image-generating element in a beam path of the radiation-emitting component,
a radiation-directing element in the beam path of the radiation-emitting component that directs the electromagnetic radiation onto the projection area, and
a radiation exit area,
wherein
the projection area is offset laterally with respect to the radiation exit area.

2. The imaging device according to claim 1, wherein
the image-generating element has an optical element that is at least partly transmissive to the electromagnetic radiation and/or an at least partly reflective optical element.

3. The imaging device according to claim 1, wherein
the image-generating element is disposed downstream of the radiation-emitting component in the beam path, and
the radiation-directing element is disposed downstream of the image-generating element in the beam path of the radiation-emitting component.

4. The imaging device according to claim 2, wherein
the at least partly transmissive optical element has at least two regions which have a mutually different transmission for the electromagnetic radiation.

5. The imaging device according to claim 4, wherein
the at least partly transmissive optical element has a matrix that is at least partly transparent to the electromagnetic radiation.

6. The imaging device according to claim 5, wherein
the at least partly transmissive optical element comprises a liquid crystal matrix and/or a structured color filter.

7. The imaging device according to claim 1, wherein
the radiation-directing element comprises a lens or a lens segment.

8. The imaging device according to claim 7, wherein
the lens or the lens segment is arranged off center with respect to the beam path of the radiation-emitting component.

9. The imaging device according to claim 1, wherein
the radiation-directing element and the image-generating element are formed in one optical element.

10. The imaging device according to claim 1, wherein
the radiation-directing element and/or the image-generating element has a mirror that is at least partly reflective for the electromagnetic radiation.

11. The imaging device according to claim 1, wherein
the emission direction of the radiation-emitting component is directed away from the projection area.

12. The imaging device according to claim 1, wherein the radiation-emitting component has a radiation-emitting semiconductor layer sequence.

13. The imaging device according to claim 1, wherein
the radiation-emitting component, the image-generating element, the radiation-directing element and the radiation exit area are arranged in a housing, and
the radiation exit area is formed as an opening or window in the housing.

14. The imaging device according to claim 1, wherein
the radiation exit area is arranged such that it is not parallel to the projection area.

15. The imaging device according to claim 1, wherein
the radiation exit area is oriented perpendicular to the projection area.

16. The imaging device according to claim 2, wherein
the image-generating element is disposed downstream of the radiation-emitting component in the beam path, and
the radiation-directing element is disposed downstream of the image-generating element in the beam path of the radiation-emitting component.

17. The imaging device according to claim 2, wherein
the radiation-directing element comprises a lens or a lens segment.

18. The imaging device according to claim 2, wherein
the radiation-directing element and the image-generating element are formed in one optical element.

19. The imaging device according to claim 2, wherein
the radiation-directing element and/or the image-generating element has a mirror that is at least partly reflective for the electromagnetic radiation.

20. The imaging device according to claim 2, wherein
the emission direction of the radiation-emitting component is directed away from the projection area.
